(19) United States
(12) Patent Application Publication
(10) Pub. No.: US 2022/0311130 A1
(43) Pub. Date: Sep. 29, 2022

(54) ANTENNA FEED NETWORKS AND RELATED ANTENNAS AND METHODS

(71) Applicant: CommScope Technologies LLC, Hickory, NC (US)

(72) Inventors: Changfu CHEN, Suzhou (CN); Hangsheng WEN, Suzhou (CN)

(21) Appl. No.: 17/619,169

(22) PCT Filed: Jun. 19, 2020
(86) PCT No.: PCT/US2020/038655

§ 371 Date: Dec. 14, 2021

(30) Foreign Application Priority Data
Jul. 3, 2019 (CN) 201910595046.5

(51) Int. Cl. H01Q 1/24; H01Q 21/00; H01Q 21/06; H01Q 3/28; H01Q 3/36; H01Q 5/50

(52) U.S. Cl. CPC H01Q 1/246; H01Q 21/0006; H01Q 21/062; H01Q 3/28; H01Q 3/36; H01Q 5/50

(57) ABSTRACT

An antenna comprises an array of radiating elements including a first column located at a side portion of the antenna and a second column located at a middle portion of the antenna. A feed network for the antenna comprises a filter at least partially filtering out a signal within the first sub-band of an operating frequency band of the antenna, such that the signal strength of a first sub-component of the signal within the first sub-band for the first column is smaller than the signal strength of a second sub-component of the signal within the first sub-band for the second column, and the signal strength of a first sub-component of the signal within a second sub-band of the operating frequency band of the antenna for the first column is not smaller than the signal strength of a second sub-component of the signal within the second sub-band for the second column.

### CROSS-REFERENCE TO RELATED APPLICATION

The present application claims priority to Chinese Patent Application No. 201910595046.5, filed Jul. 3, 2019, the entire content of which is incorporated herein by reference as if set forth fully herein

### FIELD

The present invention relates to the field of communications, and more particularly to feed networks for antennas, antennas, a feed method for antennas, and a method of operating antennas.

### BACKGROUND

Each cell in a cellular communication system has one or more antennas that are configured to provide two-way wireless radio frequency (RF) communication to mobile users geographically located within the cell. While a single antenna may be used to provide cellular service throughout the cell, multiple antennas are typically used and each antenna is configured to provide service to a respective sector of the cell. Typically, the multiple sector antennas are arranged on a tower and serve respective sectors by forming radiation beams (also referred to herein as “antenna beams”) that face outwardly in different directions in the horizontal or “azimuth” plane.

FIG. 1A is a schematic diagram of a conventional base station 10. As shown in FIG. 1A, base station 10 includes an antenna 20 that may be mounted on raised structure 30. In the depicted embodiment, the raised structure 30 is a small antenna tower, but it will be appreciated that a wide variety of mounting locations may be used including, for example, utility poles, buildings, water towers and the like. As is further shown in FIG. 1A, the base station 10 also includes base station equipment, such as baseband units 40 and radios 42. A single baseband unit 40 and a single radio 42 are shown in FIG. 1A to simplify the drawing, but it will be appreciated that more than one baseband unit 40 and/or radio 42 may be provided. Additionally, while the radio 42 is shown as being co-located with the baseband unit 40 at the bottom of the raised structure 30, it will be appreciated that in other cases the radio 42 may be a remote radio head that is mounted on the raised structure 30 adjacent the antenna 20. The baseband unit 40 may receive data from another source such as, for example, a backhaul network (not shown) and may process this data and provide a data stream to the radio 42. The radio 42 may generate RF signals that include the data encoded therein and may amplify and deliver these RF signals to the antenna 20 for transmission via a cabling connection 44. It will also be appreciated that the base station 10 of FIG. 1A will typically include various other equipment (not shown) such as, for example, a power supply, backup batteries, a power bus, Antenna Interface Signal Group (“AISG”) controllers and the like.

Typically, a base station antenna includes one or more phase-controlled arrays of radiating elements, with the radiating elements arranged in one or more vertical columns (a “column” herein, unless otherwise specified, refers to a column oriented in a vertical direction) when the antenna is mounted for use. Herein, “vertical” refers to a direction that is perpendicular relative to the plane defined by the horizon. Elements in the antenna that are referred to as being arranged, disposed or extending in a vertical direction means that when the antenna is mounted on a support structure for operation and there is no physical tilt, the elements are arranged, disposed or extending in a direction that is perpendicular relative to the plane defined by the horizon.

In a cellular base station having a conventional “3-sector” configuration, each sector antenna typically has a beamwidth of about 65° in the azimuth plane (a “beamwidth” herein, unless otherwise specified, refers to a half-power (−3 dB) beamwidth), as shown in FIG. 1B. A base station may alternatively have a 6-sector configuration that may be used to increase system capacity. In a 6-sector cellular configuration, so-called “twin-beam” antennas are typically used that generate two separate antenna beams that point in different directions in the azimuth plane. Each antenna beam may have a narrower beamwidth as compared to the antenna beams generated by antennas used in 3-sector configurations, for example, a beamwidth of about 33°, and the two antenna beams may point towards the middle of respective adjacent sectors in the azimuth plane, as shown in FIG. 1C, which is an exemplary radiation pattern in the azimuth plane for a dual-beam antenna. The antenna beams having narrower beamwidths may be generated, for example, by including multiple columns of radiating elements in a base station antenna, for example 3 or 4 columns of radiating elements. Dual-beam antennas may be used to obtain the performance improvements provided by 6-sector base station configurations without increasing the number of antennas on the tower.

### SUMMARY

A first aspect of this invention is to provide a feed network for an antenna. The operating frequency band of the antenna comprises a first sub-band and a second sub-band that is at lower frequencies than the first sub-band, wherein the antenna comprises an array of radiating elements, the array of radiating elements including a first column of radiating elements that is located at a side portion of the array of radiating elements and a second column of radiating elements that is located at a middle portion of the array of radiating elements, the feed network comprises a first filter configured to at least partially filter out a signal within the first sub-band, and the feed network is configured to feed the first column of radiating elements via the first filter and to not feed the second column of radiating elements via the first filter, such that the signal strength of a first sub-component of the signal within the first sub-band that is fed to the first column of radiating elements is smaller than the signal strength of a second sub-component of the signal within the first sub-band that is fed to the second column of radiating elements, and the signal strength of a first sub-component of the signal within the second sub-band that is fed to the first column of radiating elements is not smaller than the signal strength of a second sub-component of the signal within the second sub-band that is fed to the second column of radiating elements.

A second aspect of this invention is to provide a feed network for an antenna. The operating frequency band of the antenna comprises a first sub-band and a second sub-band that is at lower frequencies than the first sub-band, wherein the antenna comprises an array of radiating elements, the array of radiating elements including a first column of radiating elements that is located at a side portion of the array of radiating elements and a second column of radiating elements that is located at a middle portion of the array of radiating elements, the feed network comprises a first attenuator that attenuates signals within the first sub-band, and the feed network is configured to feed the first column of radiating elements via the first attenuator and to not feed the second column of radiating elements via the first attenuator, such that the signal strength of a first sub-component of the signal within the first sub-band that is fed to the first column of radiating elements is smaller than the signal strength of a second sub-component of the signal within the first sub-band that is fed to the second column of radiating elements, and the signal strength of a first sub-component of the signal within the second sub-band that is fed to the first column of radiating elements is not smaller than the signal strength of a second sub-component of the signal within the second sub-band that is fed to the second column of radiating elements.

A third aspect of this invention is to provide a feed network for an antenna. The operating frequency band of the antenna comprises a first sub-band and a second sub-band that is at higher frequencies than the first sub-band, wherein the antenna comprises an array of radiating elements, the array of radiating elements including a first column of radiating elements that is located at a middle portion of the array of radiating elements and a second column of radiating elements that is located at a side portion of the array of radiating elements, the feed network comprises a first filter that is configured to at least partially filter out a signal within the first sub-band, and the feed network is configured to feed the first column of radiating elements via the first filter and to not feed the second column of radiating elements via the first filter, such that the signal strength of a first sub-component of the signal within the first sub-band that is fed to the first column of radiating elements is smaller than the signal strength of a second sub-component of the signal within the first sub-band that is fed to the second column of radiating elements, and the signal strength of a first sub-component of the signal within the second sub-band that is fed to the first column of radiating elements is not smaller than the signal strength of a second sub-component of the signal within the second sub-band that is fed to the second column of radiating elements.

A fourth aspect of this invention is to provide a feed network for an antenna. The operating frequency band of the antenna comprises a first sub-band and a second sub-band that is at lower frequencies than the first sub-band, wherein the antenna comprises an array of radiating elements, the array of radiating elements including a plurality of rows of radiating elements that are oriented in a horizontal direction, respectively, wherein each row of radiating elements includes a first radiating element which is closer to a side portion of the array of radiating elements and a second radiating element which is closer to a middle portion of the array of radiating elements, the feed network comprises a plurality of power dividers that correspond to the respective plurality of rows of radiating elements, each power divider feeds the first and second radiating elements in each row of radiating elements, wherein the feed network further comprises a plurality of first filters, each of which is provided in a feed path of the corresponding power divider that feeds the first radiating element and is configured to at least partially filter out a signal within the first sub-band in the signals that pass on the feed path, and the plurality of first filters are configured such that a first sub-component of the signal that is fed to the first radiating element of each row of radiating elements has a first signal strength, and the strength of a second sub-component of the signal that is fed to the second radiating element of each row of radiating elements has a second signal strength, where the first signal strength is smaller than the second signal strength for the first sub-band, and the first signal strength is not smaller than the second signal strength for the second sub-band.

A fifth aspect of this invention is to provide an antenna. The antenna has an operating frequency band that comprises a first sub-band and a second sub-band that is at lower frequencies than the first sub-band, the antenna comprising: an array of radiating elements, the array of radiating elements comprising a first column of radiating elements that is located at a side portion of the array of radiating elements and a second column of radiating elements that is located at a middle portion of the array of radiating elements; and a feed network as described above.

A sixth aspect of this invention is to provide an antenna. The antenna has an operating frequency band that comprises a first sub-band and a second sub-band that is at lower frequencies than the first sub-band, the antenna comprising: a first array of radiating elements for generating a first antenna beam in an azimuth plane, the first array comprising a first column of radiating elements that is located at a side portion of the first array of radiating elements and a second column of radiating elements that is located at a middle portion of the first array of radiating elements; a second array of radiating elements for generating a second antenna beam in the azimuth plane, the second array comprising a third column of radiating elements that is located at a side portion of the second array of radiating elements and a fourth column of radiating elements that is located at a middle portion of the second array of radiating elements, wherein the first array of radiating elements and the second array of radiating elements are positioned to have a mechanical tilt relative to each other such that the first antenna beam and the second antenna beam have different pointing directions in the azimuth plane; a first feed network comprising a first filter, the first filter being configured to at least partially filter out a first signal within the first sub-band, the first feed network being configured to feed the first column of radiating elements via the first filter and to not feed the second column of radiating elements via the first filter, such that the signal strength of a first sub-component of the first signal within the first sub-band that is fed to the first column of radiating elements is smaller than the signal strength of a second sub-component of the first signal within the first sub-band that is fed to the second column of radiating elements, and the signal strength of a first sub-component of the first signal within the second sub-band that is fed to the first column of radiating elements is not smaller than the signal strength of a second sub-component of the first signal within the second sub-band that is fed to the second column of radiating elements; and a second feed network comprising a second filter, the second filter being configured to at least partially filter out a second signal within the first sub-band, the second feed network being configured to feed the third column of radiating elements via the second filter and to not feed the fourth column of radiating elements via the second filter, such that the signal strength of a third sub-component of the second signal within the first sub-band that is fed to the third column of radiating elements is smaller than the signal strength of a fourth sub-component of the second signal within the first sub-band that is fed to the fourth column of radiating elements, and the signal strength of a third sub-component of the second signal within the second sub-band that is fed to the third column of radiating elements is not smaller than the signal strength of a fourth sub-component of the second signal within the second sub-band that is fed to the fourth column of radiating elements.

A seventh aspect of this invention is to provide a method of feeding an antenna. The operating frequency band of the antenna comprises a first sub-band and a second sub-band that is at lower frequencies than the first sub-band, wherein the antenna comprises an array of radiating elements, and the array of radiating elements comprises a first column of radiating elements that is located at a side portion of the array of radiating elements and a second column of radiating elements that is located at a middle portion of the array of radiating elements, the method comprising: attenuating signals within the first sub-band in signals that are fed to the first column of radiating elements, such that the signal strength of a first sub-component of a first signal within the first sub-band that is fed to the first column of radiating elements is smaller than the signal strength of a second sub-component of a first signal within the first sub-band that is fed to the second column of radiating elements, and the signal strength of a first sub-component of a first signal within the second sub-band that is fed to the first column of radiating elements is not smaller than the signal strength of a second sub-component of a first signal within the second sub-band that is fed to the second column of radiating elements.

An eighth aspect of this invention is to provide a method of operating an antenna. The operating frequency band of the antenna comprises a first sub-band and a second sub-band that is at lower frequencies than the first sub-band, wherein the antenna comprises an array of radiating elements, and the array of radiating elements comprises a first column of radiating elements that is located at a side portion of the array of radiating elements and a second column of radiating elements that is located at a middle portion of the array of radiating elements, the method comprising: transmitting, by the first column of radiating elements, a filtered signal, and transmitting, by the second column of radiating elements, a signal that is not filtered, wherein the signal strength of a first sub-component of a signal within the first sub-band that is transmitted by the first column of radiating elements is smaller than the signal strength of a second sub-component of the signal within the first sub-band that is transmitted by the second column of radiating elements, and the signal strength of a first sub-component of the signal within the second sub-band that is transmitted by the first column of radiating elements is not smaller than the signal strength of a second sub-component of the signal within the second sub-band that is transmitted by the second column of radiating elements.

Further features of the present invention and advantages thereof will become apparent from the following detailed description of exemplary embodiments with reference to the attached drawings.

### BRIEF DESCRIPTION OF THE DRAWING

FIG. 1A is a simplified schematic diagram showing a conventional base station in a cellular communication system.

FIG. 1B is an exemplary radiation pattern in the azimuth plane of a sector antenna that is suitable for use in a conventional 3-sector cellular configuration.

FIG. 1C is an exemplary radiation pattern in the azimuth plane of a dual-beam antenna that is suitable for use in a conventional 6-sector cellular configuration.

FIG. 2A is a simplified schematic diagram showing a conventional antenna.

FIG. 2B is a schematic diagram of one of the power dividers in FIG. 2A.

FIG. 2C is a schematic diagram of strength of signals that are fed to the array of radiating elements in FIG. 2A.

FIG. 3A is a simplified schematic diagram showing an antenna according to an embodiment of the present invention.

FIG. 3B is a schematic diagram of an implementation of one of the filtering-dividing modules in FIG. 3A according to an embodiment of the present invention.

FIG. 3C is a schematic diagram of an implementation of one of the filtering-dividing modules of FIG. 3A according to a further embodiment of the present invention.

FIG. 3D is a schematic diagram of strength of signals that are fed to the array of radiating elements of FIG. 3A.

FIG. 4 is a graph schematically illustrating a frequency response of a filter that is included in a feed network according to an embodiment of the present invention.

FIG. 5A is a graph schematically illustrating exemplary azimuth patterns for RF signals at several different frequencies for a conventional antenna.

FIG. 5B is a graph schematically illustrating exemplary azimuth patterns for RF signals at several different frequencies for an antenna according to an embodiment of the present invention.

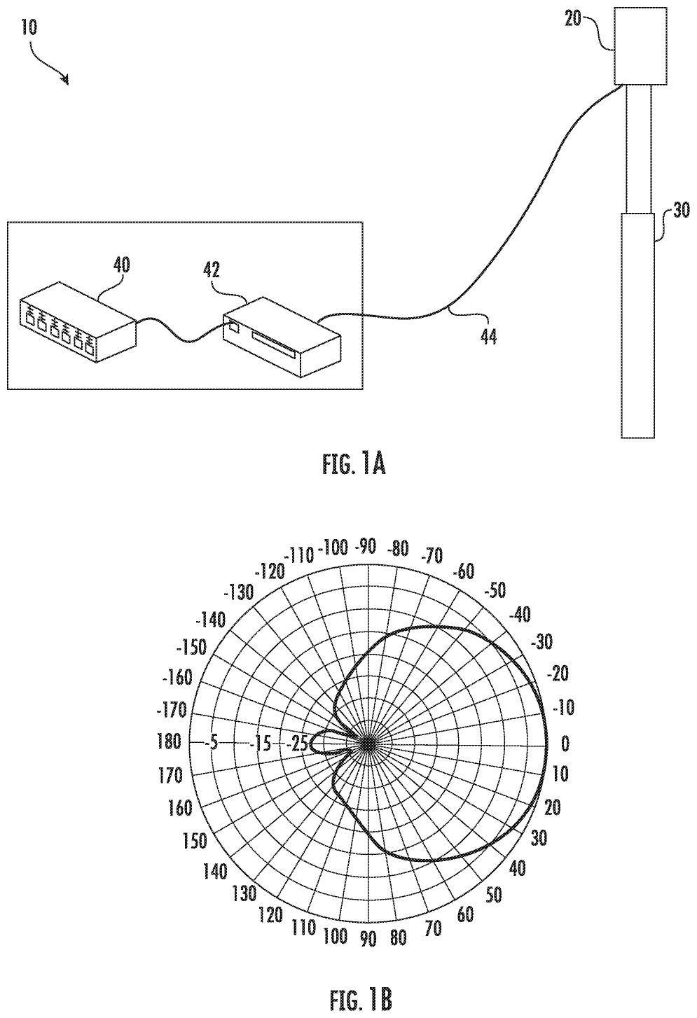

Note that, in some cases the same elements or elements having similar functions are denoted by the same reference numerals in different drawings, and description of such elements is not repeated. In some cases, similar reference numerals and letters are used to refer to similar elements, and thus once an element is defined with reference to one figure, it need not be further discussed with reference to subsequent figures.

The position, size, range, or the like of each structure illustrated in the drawings may not be drawn to scale. Thus, the invention is not necessarily limited to the position, size, range, or the like as disclosed in the drawings.

### DETAILED DESCRIPTION

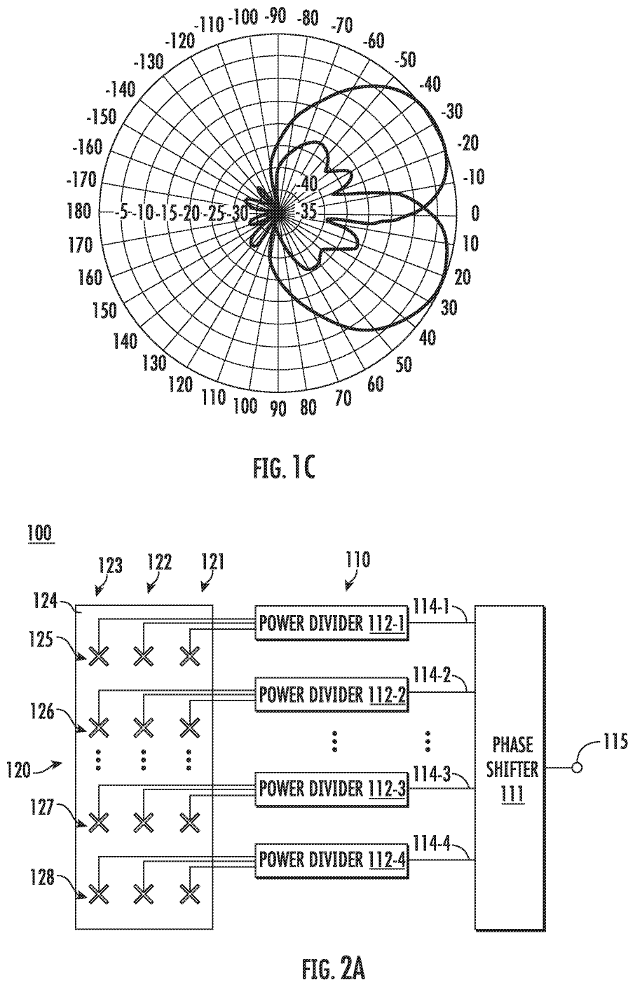

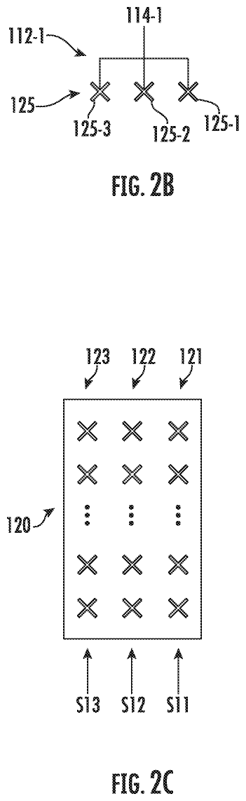

FIG. 2A is a simplified schematic diagram showing a conventional antenna 100. The antenna 100 includes a feed network 110, and an array of radiating elements 120. The array of radiating elements 120 includes a plurality of columns 121-123 of radiating elements that are mounted on a backplane 124. An RF signal may be transmitted through the radiating elements in all three columns 121-123. Since the RF signal is transmitted through multiple, horizontally spaced-apart columns of radiating elements, the resultant antenna beam has a narrower beamwidth in the azimuth plane. The feed network 110 may be connected via a port 115 to a radio (not shown) to receive RF signals therefrom and to transmit RF signals thereto. The feed network 110 processes the RF signals from the radio and feeds the RF signals to the array of radiating elements 120. As shown in FIG. 2A, RF signals received at port 115 are input to a phase shifter 111. The phase shifter 111 splits the received RF signal into a plurality of sub-components, and applies a phase taper across the sub-components. As known to those of skill in the art, by applying a phase taper to the sub-components of an RF signal that are fed to different radiating elements in a column (or multiple columns) of radiating elements, an electrical downtilt may be applied to the resultant antenna beam, which may be used to adjust the size of the region that is “covered” by the antenna beam. The outputs 114-1 to 114-4 of phase shifter 111 feed respective rows of radiating elements 125 to 128 via respective power dividers 112-1 to 112-4. Herein, a column of radiating elements refers to one or more radiating elements oriented in a vertical direction, and a row of radiating elements refers to one or more radiating elements oriented in a horizontal direction. Taking the row of radiating elements 125 as an example, as shown in FIG. 2B, the sub-component of an RF signal that is passed through the output 114-1 of the phase shifter 111 is further split by the power divider 112-1 into three smaller sub-components, and the sub-components of the RF signal that are output through the three output legs of the power divider 112-1 are fed to respective radiating elements 125-1 to 125-3 in the row 125, respectively. The signal strengths (e.g., power) S11 to S13 of signals that are fed to a particular row of radiating elements 125 to 128 in the array of radiating elements 120 via the feed network 110 may be the same (for example, the ratio of signal strengths S11, S12, S13 may be 1:1:1), or may also be different (for example, the ratio of signal strengths S11, S12, S13 may be 0.7:1:0.7). An amplitude taper may optionally be applied to the radiating elements in each column 121 to 123. For example, in some embodiments, the radiating elements in rows 125 and/or 128 may receive less signal power than the radiating elements in rows 126 and/or 127.

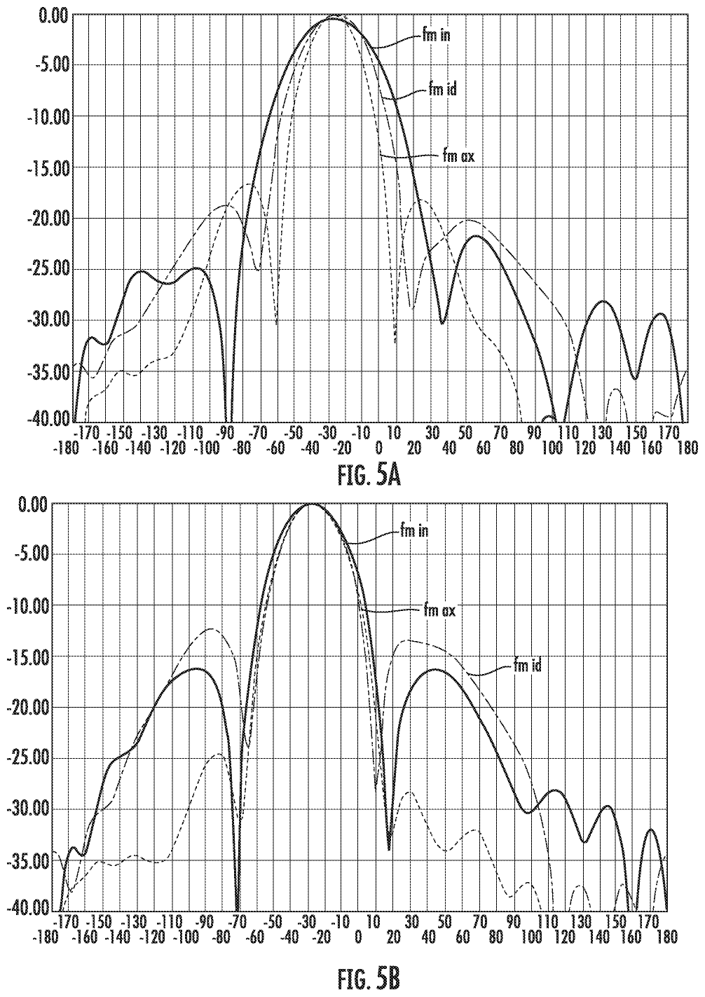

The azimuth beamwidth of antenna 100 will vary with frequency. When the operating frequency band of the antenna is wide (for example, when the antenna 100 operates in the 1695-2690 MHz band), the amount of variation in the azimuth beamwidth may become unacceptably large. FIG. 5A is a graph schematically illustrating an azimuth pattern for a conventional antenna (i.e., a graph of the strength of the signal radiation as a function of the azimuth angle). The graph of FIG. 5A includes three curves, each of which corresponds to a different frequency. In particular, the solid line in FIG. 5A corresponds to the lowest operating frequency fmin of the antenna 100, for example 1695 MHz, the dash line corresponds to the highest operating frequency fmax, for example 2690 MHz, and the dotted line corresponds to an operating frequency fmid that is between fmin and fmax, for example 2200 MHz. As shown in FIG. 5A, the azimuth beamwidth at frequency fmin is about 40°, the azimuth beamwidth at frequency fmid is about 35°, and the azimuth beamwidth at frequency fmax is about 25°. It can be seen that the difference between the azimuth beamwidth at the lowest operating frequency fmin and the azimuth beamwidth at the highest operating frequency fmax is about 15°. As a result, the size of the coverage area for the antenna 100 will vary significantly based on the frequency of the RF signal within the operating frequency band of the antenna, which is undesirable.

Pursuant to embodiments of the present invention, feed networks for base station antennas are provided that may exhibit reduced variation in azimuth beamwidth across the operating frequency band of the antennas. The feed networks according to embodiments of the present invention include one or more filters that may at least partially filter out signals within a specific frequency range that are fed to at least some of the columns of radiating elements in the array of radiating elements. For example, a filter may be disposed on a feed path to at least one column of radiating elements that is located at a side portion of the array of radiating elements and may at least partially filter out signals within a higher portion of the operating frequency band in the feed signals. Thus, for a signal within the higher portion of the operating frequency band, due to filtering by the filter, the signal strength of the sub-components of the signal that are fed to the radiating elements in at least one column of the radiating elements that is located at the side portion of the array of radiating elements may be smaller than the signal strength of the sub-components of the signal that are fed to the radiating elements in at least one column of the radiating elements that is located at a middle portion of the array of radiating elements; and for a signal within a lower portion of the operating frequency band, as it is not processed by the filter, the signal strength of the sub-components of the signal that are fed to the radiating elements in at least one column of radiating elements that is located at the side portion of the array of radiating elements is not smaller than the signal strength of the sub-components of the signal that are fed to the radiating elements in at least one column of radiating elements that is located at a middle portion of the array of radiating elements. This filtering of the signal within the higher portion of the operating frequency band broadens the azimuth beamwidth of the antenna beam within the higher portion of the operating frequency band, such that the difference between the azimuth beamwidths of the antenna beams within the higher and lower portions of the operating frequency bands may be reduced.

A feed network according to another embodiment of the present invention may include a first filter and a second filter, where the first filter is configured to at least partially filter out a signal within a higher portion of the operating frequency band that is fed to at least one column of radiating elements that is located at a side portion of the array of radiating elements, and the second filter is configured to at least partially filter out a signal within a lower portion of the operating frequency band that is fed to at least one column of radiating elements that is located at a middle portion of the array of radiating elements. Thus, for signals within the higher portion of the operating frequency band, the signal strength of the sub-components of the signal that are fed to the radiating elements in at least one column of radiating elements that is located at the side portion of the array of radiating elements is less than the signal strength of the sub-components of the signal that are fed to the radiating elements in at least one column of radiating elements that is located at the middle portion of the array of radiating elements; while for the signals within the lower portion of the operating frequency band, the signal strength of the sub-components of the signal that are fed to the radiating elements in at least one column of radiating elements that is located at the side portion of the array of radiating elements is greater than the signal strength of the sub-components of the signal that are fed to the radiating elements in at least one column of the radiating elements that is located at the middle portion of the array of radiating elements. This filtering of signals within the higher and lower portions of the operating frequency band allows the azimuth beamwidth of the antenna beam within the higher portion of the operating frequency band to be broadened and the azimuth beamwidth of the antenna beam within the lower portion of the operating frequency band to be narrowed, so that the difference between the azimuth beamwidths of the antenna beams generated in the higher and lower portions of the operating frequency band is reduced. FIG. 5B is a graph schematically illustrating an azimuth pattern for an antenna according to an embodiment of the present invention. In the graph, the solid line corresponds to the lowest operating frequency fmin of the antenna, for example 1695 MHz, and the beamwidth at this frequency is about 34.7°; the dash line corresponds to the highest operating frequency fmax, for example 2690 MHz, and the beamwidth at this frequency is about 28.7°; the dotted line corresponds to an operating frequency fmid that is between fmin and fmax, for example 2200 MHz, and the beamwidth at this frequency is around 32.3. It can be seen that the difference between the azimuth beamwidth at the lowest operating frequency fmin and the azimuth beamwidth at the highest operating frequency fmax is only around 6°, which is significantly reduced compared to conventional antennas.

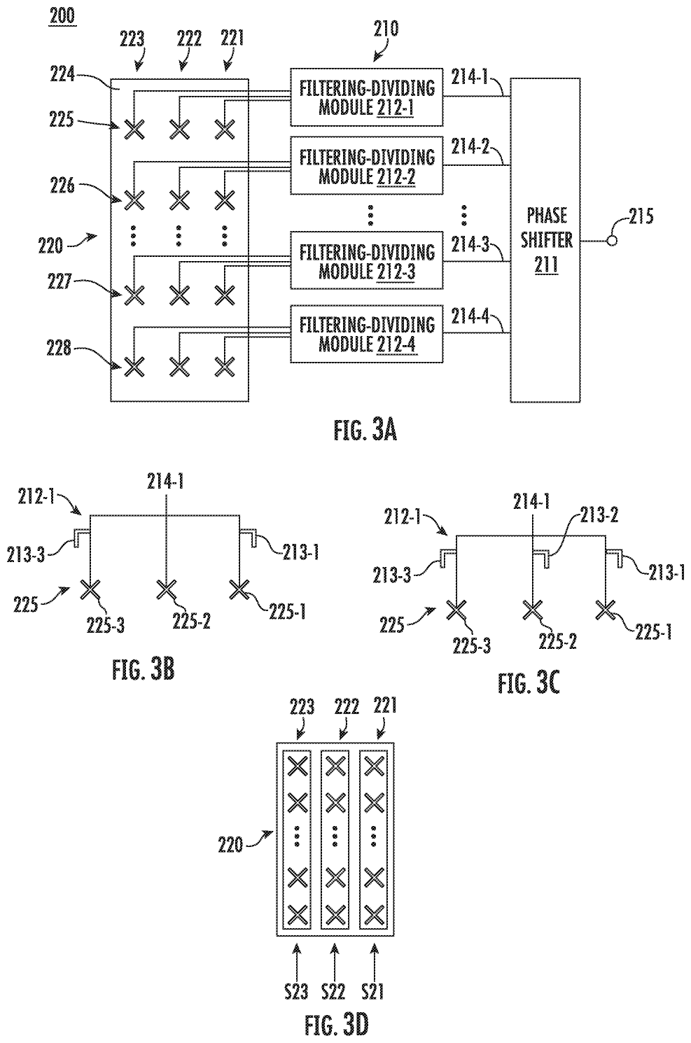

FIG. 3A is a simplified schematic diagram of an antenna 200 according to an embodiment of the present invention. The antenna 200 includes a feed network 210 in accordance with an embodiment of the present invention. It will be appreciated that in the description in conjunction with FIG. 3A, the description of the same or similar features as in the antenna 100 shown in FIGS. 2A and 2B is omitted. The feed network 210 includes a phase shifter 211 and filtering-dividing modules 212-1 to 212-4. The phase shifter 211 may be connected to a radio to receive signals from and transmit signals to the radio. The phase shifter 211 has a plurality of outputs 214-1 to 214-4 that output respective phase shifted signals. The phase shifter 211 is represented by a block in the figure. It will be appreciated that the phase shifter 211 may implemented as a single phase shifter, or may be implemented as a plurality of phase shifters.

The phase shifted signals are fed to the rows of radiating elements 225 to 228 of the array of radiating elements 220 via filtering-dividing modules 212-1 to 212-4, respectively. Each of the filtering-dividing modules 212-1 to 212-4 is configured to divide the signals from the corresponding outputs 214-1 to 214-4 of the phase shifter 211 into three smaller sub-components and to filter (at least partially filter out) signals within a specific portion of the operating frequency band. The three sub-components output by each of the filtering-dividing modules 212-1 to 212-4 are respectively fed to three radiating elements in each row of radiating elements 225 to 228. Each of the columns of radiating elements 221 to 223 includes a plurality of radiating elements arranged in a vertical direction. In the illustrated embodiment, the plurality of radiating elements are arranged in lines. However, it will be appreciated that the plurality of radiating elements may be arranged in any known pattern, for example the plurality of radiating elements oriented in a vertical direction may be staggered in the horizontal direction. In the antenna 200 shown in FIG. 3A, each column of radiating elements includes at least four radiating elements. It will be appreciated, however, that each column of radiating elements may include any number of radiating elements. Any suitable radiating element may be used including, for example, a dipole radiating element, a crossed dipole radiating element, a patch radiating element, a slot radiating element, and/or a horn radiating element, and the like. Each radiating element may be the same. The radiating elements may extend outwardly from the backplane 224 on which they are mounted.

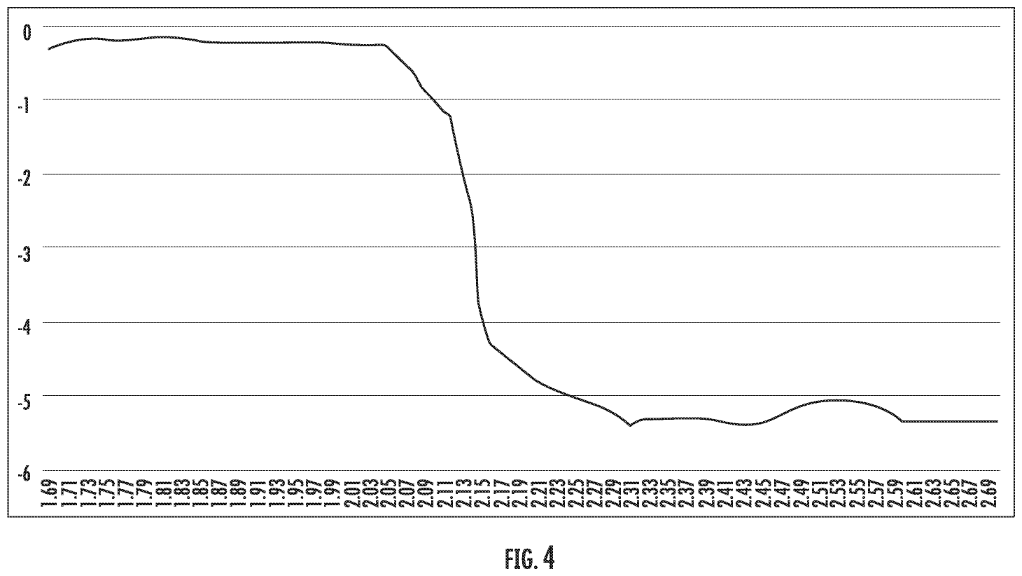

In some embodiments, each of the filtering-dividing modules 212-1 to 212-4 in FIG. 3A has a structure as shown in FIG. 3B (taking the filtering-dividing module 212-1 as an example). The filtering-dividing module 212-1 has one input and three outputs. The input is coupled to the output 214-1 of the phase shifter 211, and the three outputs are coupled to three of the radiating elements 225-1 to 225-3 in the row of radiating elements 225, respectively. The filters 213-1 and 213-3 are respectively disposed in the feed paths for radiating elements 225-1 and 225-3 (i.e., the outer radiating elements in the row), and no filter is disposed in the feed path for radiating element 225-2. The filters 213-1 and 213-3 are each configured to at least partially filter out signals within a specific portion of the operating frequency band, such as a higher portion of the operating frequency band. In a specific example, antenna 200 has an operating frequency band of 1695-2690 MHz band, and filters 213-1 and 213-3 may be configured to partially filter out signals within the upper portion of this frequency band. FIG. 4 shows a possible frequency response curve for filter 213-1 or 213-3. The filter having the frequency response curve as shown in FIG. 4 may partially filter out signals within the frequency band of 2310-2690 MHz band, so that the strength of the signal within this frequency band is attenuated to be about −5 dB lower than the strength of signals in the lower portion of the operating frequency band, thereby the ratio of the signal strength (e.g., power) within the frequency band that is fed by the feed path (e.g., the feed paths for the radiating elements 225-1 and 225-3) with the filter to the signal strength within the frequency band that is fed by the feed path (e.g., the feed path for the radiating element 225-2) without any filter is about 0.3:1. It will be appreciated that the frequency response curve of the filter 213-1 or 213-3 is not limited to the case shown in FIG. 4, as long as signals within the higher portion of the operating frequency band are attenuated.

In the depicted embodiments, the configuration of the filters in each of the filtering-dividing modules 212-1 to 212-4 in the feed paths feeding the same column of radiating elements are the same, such that the strengths of signals that are fed to the same column of radiating elements are the same. Referring to FIG. 3D, that is, by configuring each of the filtering-dividing modules 212-1 to 212-4, the strength of the signal that is fed to each of radiating elements in the column 221 is S21, the strength of the signal that is fed to each of radiating elements in the column 222 is S22, and the strength of the signal that is fed to each of radiating elements in the column 223 is S23. The inventors of the present invention have found that, as long as the ratio of the strength of the filtered signal to that of the unfiltered signal is within the range of 0.2:1 to 0.7:1 for a higher portion of the operating frequency band (that is, the ratio of the strength (e.g., S21 and S23) of the signal that is fed to at least one column of radiating elements that is located at the side portion of the array of radiating elements to the strength (e.g., S22) of the signal that is fed to at least one column of radiating elements that is located at the middle portion of the array of radiating elements is within the range of 0.2:1 to 0.7:1), it may be possible to obtain a relatively significant effect of broadening the azimuth beamwidth within the higher portion of the operating frequency band. The filter's filtering effect for signals within the higher portion of the operating frequency band may be designed as needed. For example, the ratio of the strength of the filtered signal to that of the unfiltered signal may be within the range of 0.3:1 to 0.5:1, may be 0.3:1, or may be 0.5:1. Since the filters (e.g., filters 213-1 and 213-3) in each of the filtering-dividing modules 212-1 to 212-4 partially filter out signals within the higher portion of the operating frequency band on the respective feed paths, while signals within the lower portion of the operating frequency band are not processed by the filters, the ratio of the strengths S21:S22:S23 of the signals within the lower portion of the operating frequency band that are fed to the three columns 221 to 223 may be, for example, 1:1:1. Thus, compared to the conventional antenna shown in FIGS. 2A and 2B, the azimuth beamwidth of an antenna beam generated by an RF signal within the higher portion of the operating frequency band is broadened while the beamwidth an antenna beam generated by RF an RF signal within the lower portion of the operating frequency band remains unchanged, so that the difference in the azimuth beamwidths of antenna beams generated by RF signals within the higher portion of the operating band and within the lower portion of the operating band is reduced.

It will be appreciated that it is also possible to include a filter only on the feed path for a column of radiating elements that is located at one side of the array of radiating elements while still achieving the beneficial effects of the present invention as long as the strength (e.g., S21 or S23) of the signal within the higher portion of the operating frequency band that is fed to at least one column of radiating elements that is located at the one side of the array of radiating elements is less than the strength of the signal that is fed to at least one column of radiating elements that is located in the middle portion of the array. For example, a filter may be disposed only on the feed path for the column of radiating elements 221 to partially filter out signals within the higher portion of the operating frequency band, such that the ratio of strengths S21:S22:S23 of signals within the higher portion of the operating frequency band that are fed respectively to the three columns of radiating elements 221, 222, 223 may be, for example, 0.3:1:1 and the ratio of the strengths S21:S22:S23 of the signals within the lower portion of the operating frequency band may be, for example, 1:1:1. This may also cause the azimuth beamwidth within the higher portion of the operating frequency band of the array of radiating elements to be broadened such that the difference in azimuth beamwidth within the higher portion of the operating frequency band and within the lower portion of the operating frequency band is reduced.

It will be appreciated that the filters 213-1 and 213-3 of FIG. 3B may also have different filtering effects (degree of attenuation) on signals within the higher portion of the operating frequency band for respective feed paths. For example, filters (e.g., filters 213-1 and 213-3) of each of the filtering-dividing modules 212-1 to 212-4 may be configured such that the ratio of the strengths of the signals within the higher portion of the operating frequency band fed to three columns of radiating elements 221 to 223 respectively is, for example, 0.3:1:0.4, 0.6:1:0.5, etc., and the ratio of the strengths of the signals within the lower portion of the operating frequency band is, for example, 1:1:1. This may also achieve the effects of the present invention. In some embodiments, in the case where the signal filtering effects for the two columns of radiating elements 221, 223 that are respectively located at the both sides of the array of radiating elements are the same, only one of such filter may be disposed in each of the filtering-dividing modules 212-1 to 212-4, and then signals processed by the filter are divided into at least two signals via, for example, a power divider, a power coupler or the like, in order to feed to the radiating elements of the two columns of radiating elements 221, 223, respectively.

Although all the filters described in the above description are configured to partially filter out signals within the higher portion of the operating frequency band, it will be appreciated that the filters in each of the filtering-dividing modules 212-1 to 212-4 (e.g., filters 213-1 and/or 213-3) may be configured to filter out signals within the higher portion of the operating frequency band completely. For example, a filter (e.g., filter 213-1) in each of the filtering-dividing modules 212-1 to 212-4 for the column 221 is configured to filter out signals within the higher portion of the operating frequency band completely, so that the ratio of the strengths S21:S22:S23 of the signals within the higher frequency band that are fed to three columns 221, 222, 223 respectively may be, for example, 0:1:1, 0:1:0.7, etc., which is equivalent to having only two columns of radiating elements operating within the higher portion of the operating frequency band, so that the effect of broadening the azimuth beamwidth within the higher portion of the operating frequency band may be achieved.

In some embodiments, each of the filtering-dividing modules 212-1 to 212-4 in FIG. 3A has a structure as shown in FIG. 3C (taking the filtering-dividing module 212-1 as an example). The filtering-dividing module 212-1 has one input and three outputs. The one input is coupled to the output 214-1 of the phase shifter 211, and the three outputs are coupled to three radiating elements 225-1 to 225-3 in a row of radiating elements 225, respectively. Filters 213-1 to 213-3 are respectively disposed in feed paths to the radiating elements 225-1 to 225-3. Filters 213-1 to 213-3 are each configured to at least partially filter out signals within a particular portion of the operating frequency band, wherein filters 213-1 and 213-3 are configured to at least partially filter out signals within the higher portion of the operating frequency band of antenna 200, while the filter 213-2 is configured to at least partially filter out signals within the lower portion of the operating frequency band of antenna 200.

In these embodiments, the configuration of the filters on the feed paths feeding the same column of radiating elements in each of the filtering-dividing modules 212-1 to 212-4 are the same, such that the strengths of the signals that are fed to the same column of radiating elements are the same. Referring to FIG. 3D, that is, by configuring each of the filtering-dividing modules 212-1 to 212-4, the strength of the signal that is fed to each of radiating elements in the column of radiating elements 221 is S21, the strength of the signal that is fed to each of radiating elements in the column of radiating elements 222 is S22, and the strength of the signal that is fed to each of radiating elements in the column of radiating elements 223 is S23. Each of the filtering-dividing modules 212-1 to 212-4 is configured such that the ratio of strengths S21:S22:S23 of signals within the higher portion of the operating frequency band that are fed to the three columns 221, 222, 223 may be, for example, 0.3:1:0.3 and the ratio of the strengths S21:S22:S23 of the signals within the lower portion of the operating frequency band may be, for example, 1:0.7:1. The azimuth beamwidth of the antenna beam within the higher portion of the operating frequency band is broadened and the azimuth beamwidth of the antenna beam within the lower portion of the operating frequency band is narrowed compared to the conventional antenna as shown in FIGS. 2A and 2B, thereby the difference in azimuth beamwidths of the antenna beams within the higher and lower portions of the operating frequency band is reduced. While in some embodiments all of the radiating elements in a column may receive sub-components of an RF signal that have the same strength as described above (e.g., the strength of the signal that is fed to each of radiating elements in the column of radiating elements 223 is S23), it will be appreciated that in other embodiments the radiating elements within a column may be fed with sub-components of an RF signal that have different signal strengths. For example, the sub-components of an RF signal that are fed to the radiating elements at and/or near the top and/or bottom of a column may have reduced signal strength as compared to the radiating elements in the middle of the column. In such embodiments, the relative signal strengths of the radiating elements may be the same for each row in the array of radiating elements.

In some embodiments, by configuring the filters (e.g., filter 213-2) in each filtering-dividing modules 212-1 to 212-4 that are respectively for radiating elements in at least one column of radiating elements (e.g., the column 222) that is located at the middle portion, signals within the lower portion of the operating frequency band may be completely filtered out by these filters. Thus, within the lower portion of the operating frequency band, for example, the array of radiating element 220 may be equivalent to an array that has only two columns of radiating elements 221 and 223 with a significant wider distance between the two neighboring columns, such that the azimuth beamwidth within the lower portion of the operating frequency band may be narrowed such that the difference between azimuth beamwidths of the antenna beam within the higher and lower portions of the operating frequency band is reduced.

In the example embodiments described above, specific values of the ratio of the strengths are described as an example. It will be appreciated that embodiments of the present invention are not limited thereto, as long as the filter is configured such that the strength of signals within the higher portion of the operating frequency band for at least one column of radiating elements that is located at a side of the array is less than that for at least one column of radiating elements that is located in a middle portion of the array, and the strength of signals within the lower portion of the operating frequency band for at least one column of radiating elements that is located at the middle portion of the array is less than that for at least one column of radiating elements that is located at the side portion of the array. The inventors of the present invention have found that, for the higher portion of the operating frequency band, as long as the ratio of the strength of signals that are fed to at least one column of radiating elements that is located at a side of the array to the strength of signals that are fed to at least one column of radiating elements that is located in the middle portion of the array falls within the range of 0.2:1 to 0.7:1, it may be possible to achieve a relatively significant effect of broadening the azimuth beamwidth within the higher portion of the operating frequency band; and for the lower portion of the operating frequency band, as long as the ratio of the strength of signals that are fed to at least one column of radiating elements that is located at the middle portion of the array to the strength of signals that are fed to at least one column of radiating elements that is located at a side portion of the array falls within the range of 0.5:1 to 0.9:1, it may be possible to achieve a relatively significant effect of narrowing the azimuth beamwidth within the lower portion of the operating frequency band.

In a specific example, the operating frequency band of the array of radiating elements 220 in the antenna 200 is 1695˜2690 MHz band, the higher portion of the operating frequency band may refer to 2200˜2690 MHz band, and the lower portion of the operating frequency band may refer to 1695˜2200 MHz band. Filters 213-1 and 213-3 are configured to at least partially filter out signals within the 2200˜2690 MHz band, and filter 213-2 is configured to at least partially filter out signals within the 1695˜2200 MHz band. It will be appreciated that the operating frequency band of the antenna may be divided into more than two sub-bands, i.e., the operating frequency band of the antenna may include other bands in addition to the above-described higher portion of the operating frequency band and lower portion of the operating frequency band. For example, the higher portion of the operating frequency band may refer to 2310˜2690 MHz band, and the lower portion of the operating frequency band may refer to 1695˜2050 MHz band. Filters 213-1 and 213-3 may be configured to at least partially filter out signals within the 2310˜2690 MHz band, and filter 213-2 may be configured to at least partially filter out signals within the 1695˜2050 MHz band, and all of the filters in each filtering-dividing module 212-1 to 212-4 (for example, filters 213-1 to 213-3) do not perform the above described filtering processing on signals within the 2050˜2310 MHz band.

It will be appreciated that filters may also be disposed only on the feed paths for one column of radiating elements that is located at one side portion of the array of radiating elements to at least partially filter out signals within the higher portion of the operating frequency band. It will be appreciated that the filtering effects (degree of attenuation) of the two filters on the feed paths for the two columns of radiating elements that are respectively located at both side portions of the array may be different. It will be appreciated that in the case where the signal filtering effects for the two columns that are located at both side portions of the array are the same, a common filter may be used to perform the filtering for both columns. It will be appreciated that each filter may be configured to partially or completely filter out signals within a specific frequency band. Examples for these cases may be referred to above descriptions, and duplicated explanations is omitted here.

In the embodiment described above, the array of radiating elements 220 includes three columns of radiating elements 221, 222, 223. It will be appreciated that the array of radiating elements may include more or less columns of radiating elements. For example, the array of radiating elements may include four columns of radiating elements and the four columns of radiating elements may be fed by filtering-dividing modules that are each capable of providing four outputs. In some embodiments, a filter may be disposed only on the feed path which feeds at least one column of radiating elements that is located at a side portion of the array of radiating elements to at least partially filter out signals within the higher portion of the operating frequency band, such that for the higher portion of the operating frequency band, the ratio of the strengths of the signals that are fed to the four columns of radiating elements is, for example, 0.3:1:1:0.3, 0.5:1:1:0.5, etc., and for the lower portion of the operating frequency band, the ratio of strengths of the signals that are fed to the four columns of radiating elements is 1:1:1:1. In some embodiments, a filter may be disposed on the feed path which feeds at least one column of radiating elements that is located at a side portion of the array of radiating elements to at least partially filter out signals within the higher portion of the operating frequency band, and a filter is disposed in the feed path feeding at least one column of radiating element that is located within the middle portion of the array of radiating elements to at least partially filter out signals within the lower portion of the operating frequency band, such that for higher portion of the operating frequency band, the ratio of the strengths of the signals that are fed to the four columns of radiating elements is, for example, 0.3:1:1:0.3, 0.5:1:1:0.5, etc., and for the lower portion of the operating frequency band, the ratio of the strengths of the signals that are fed to the four columns of radiating elements is, for example, 1:0.5:0.5:1, 1:0.9:0.9:1 and so on.

In some embodiments, the invention may be used in dual-beam antennas as well as multiple beam antennas. For example, an antenna according to embodiments of the present invention may include two arrays of radiating elements having a particular mechanical tilt in the azimuth plane with respect to each other, wherein the feed network for at least one of the two arrays of radiating elements may be as described in any of the embodiments above. In some embodiments, an attenuator may be used to replace any of the filters in the above embodiments. In some embodiments, the functionality of the filters in the above embodiments may be implemented in a multiplexer with filtering function.

It will be appreciated that the antenna may also include other conventional components not shown in the drawings, such as a radome, a reflector assembly and a plurality of circuit components and other structures mounted therein.

Embodiments are described herein primarily with respect to operations of base station antennas in a transmitting mode in which an array of radiating elements emits signals. It will be appreciated that base station antennas according to embodiments of the present invention may operate in a transmitting mode and/or a receiving mode in which an array of radiating elements receives signals. The filters described herein may at least partially filter out signals within a specific portion of the operating frequency band for such received signals in order to reduce the difference between the beamwidths of the antenna beams generated in response to signals within the higher and lower portion of the operating frequency bands for the received signals.

The present invention has been described with reference to the accompanying drawings, which show a number of example embodiments thereof. It should be understood, however, that the present invention can be embodied in many different ways, and is not limited to the embodiments described below. Rather, the embodiments described below are intended to make the disclosure of the present invention more complete and fully convey the scope of the present invention to those skilled in the art. It should also be understood that the embodiments disclosed herein can be combined in any way to provide many additional embodiments.

The terminology used herein is for the purpose of describing particular embodiments, but is not intended to limit the scope of the present invention. All terms (including technical terms and scientific terms) used herein have meanings commonly understood by those skilled in the art unless otherwise defined. For the sake of brevity and/or clarity, well-known functions or structures may be not described in detail.

Herein, when an element is described as located “on” “attached” to, “connected” to, “coupled” to or “in contact with” another element, etc., the element can be directly located on, attached to, connected to, coupled to or in contact with the other element, or there may be one or more intervening elements present. In contrast, when an element is described as “directly” located “on”, “directly attached” to, “directly connected” to, “directly coupled” to or “in direct contact with” another element, there are no intervening elements present. In the description, references that a first element is arranged “adjacent” a second element can mean that the first element has a part that overlaps the second element or a part that is located above or below the second element.

Herein, the foregoing description may refer to elements or nodes or features being “connected” or “coupled” together. As used herein, unless expressly stated otherwise, “connected” means that one element/node/feature is electrically, mechanically, logically or otherwise directly joined to (or directly communicates with) another element/node/feature. Likewise, unless expressly stated otherwise, “coupled” means that one element/node/feature may be mechanically, electrically, logically or otherwise joined to another element/node/feature in either a direct or indirect manner to permit interaction even though the two features may not be directly connected. That is, “coupled” is intended to encompass both direct and indirect joining of elements or other features, including connection with one or more intervening elements.

Herein, terms such as “upper”, “lower”, “left”, “right”, “front”, “rear”, “high”, “low” may be used to describe the spatial relationship between different elements as they are shown in the drawings. It should be understood that in addition to orientations shown in the drawings, the above terms may also encompass different orientations of the device during use or operation. For example, when the device in the drawings is inverted, a first feature that was described as being “below” a second feature can be then described as being “above” the second feature. The device may be oriented otherwise (rotated 90 degrees or at other orientation), and the relative spatial relationship between the features will be correspondingly interpreted.

Herein, the term “A or B” used through the specification refers to “A and B” and “A or B” rather than meaning that A and B are exclusive, unless otherwise specified.

The term “exemplary”, as used herein, means “serving as an example, instance, or illustration”, rather than as a “model” that would be exactly duplicated. Any implementation described herein as exemplary is not necessarily to be construed as preferred or advantageous over other implementations. Furthermore, there is no intention to be bound by any expressed or implied theory presented in the detailed description.

Herein, the term “substantially”, is intended to encompass any slight variations due to design or manufacturing imperfections, device or component tolerances, environmental effects and/or other factors. The term “substantially” also allows for variation from a perfect or ideal case due to parasitic effects, noise, and other practical considerations that may be present in an actual implementation.

Herein, certain terminology, such as the terms “first”, “second” and the like, may also be used in the following description for the purpose of reference only, and thus are not intended to be limiting. For example, the terms “first”, “second” and other such numerical terms referring to structures or elements do not imply a sequence or order unless clearly indicated by the context.

Further, it should be noted that, the terms “comprise”, “include”, “have” and any other variants, as used herein, specify the presence of stated features, steps, operations, elements, and/or components, but do not preclude the presence or addition of one or more other features, steps, operations, elements, components, and/or groups thereof.

Although some specific embodiments of the present invention have been described in detail with examples, it should be understood by a person skilled in the art that the above examples are only intended to be illustrative but not to limit the scope of the present invention. The embodiments disclosed herein can be combined arbitrarily with each other, without departing from the scope and spirit of the present invention. It should be understood by a person skilled in the art that the above embodiments can be modified without departing from the scope and spirit of the present invention. The scope of the present invention is defined by the attached claims.

1. A feed network for an antenna, the operating frequency band of the antenna comprising a first sub-band and a second sub-band that is at lower frequencies than the first sub-band, wherein
the antenna comprises an array of radiating elements, the array of radiating elements including a first column of radiating elements that is located at a side portion of the array of radiating elements and a second column of radiating elements that is located at a middle portion of the array of radiating elements,
the feed network comprises a first filter configured to at least partially filter out a signal within the first sub-band, and
the feed network is configured to feed the first column of radiating elements via the first filter and to not feed the second column of radiating elements via the first filter, such that the signal strength of a first sub-component of the signal within the first sub-band that is fed to the first column of radiating elements is smaller than the signal strength of a second sub-component of the signal within the first sub-band that is fed to the second column of radiating elements, and the signal strength of a first sub-component of a signal within the second sub-band that is fed to the first column of radiating elements is not smaller than the signal strength of a second sub-component of the signal within the second sub-band that is fed to the second column of radiating elements.

2. The feed network of claim 1, wherein the feed network further comprises a second filter that is configured to at least partially filter out the signal within the first sub-band, and
the feed network is configured to feed a third column of radiating elements that is located at a second side portion of the array of radiating elements via the second filter and to not feed the second column of radiating elements via the second filter, such that the signal strength of a third sub-component of the signal within the first sub-band that is fed to the third column of radiating elements is smaller than the signal strength of the second sub-component of the signal within the first sub-band that is fed to the second column of radiating elements, and the signal strength of a third sub-component of the signal within the second sub-band that is fed to the third column of radiating elements is not smaller than the signal strength of the second sub-component of the signal within the second sub-band that is fed to the second column of radiating elements.

3. The feed network of claim 2, wherein the first filter and the second filter are configured such that the first and third sub-components of the signal within the first sub-band that are fed to the first column of radiating elements and the third column of radiating elements via the first filter and the second filter, respectively, have the same signal strength.

4. The feed network of claim 1, wherein the ratio of the signal strength of the first sub-component of the signal within the first sub-band that is fed to the first column of radiating elements to the signal strength of the second sub-component of the signal within the first sub-band that is fed to the second column of radiating elements is in the range of 0.2:1 to 0.7:1.

5. The feed network of claim 1, wherein the ratio of the signal strength of the first sub-component of the signal within the first sub-band that is fed to the first column of radiating elements to the signal strength of the second sub-component of the signal within the first sub-band that is fed to the second column of radiating elements is 0.3:1.

6. The feed network of claim 2, wherein the ratio of the signal strengths of the respective first, second and third sub-components of the signal within the first sub-band that are respectively fed to the first column of radiating elements, the second column of radiating elements and the third column of radiating elements is 0.3:1:0.3.

7. The feed network of claim 1, wherein
the feed network further comprises a third filter that is configured to at least partially filter out a signal within the second sub-band, and
the feed network is further configured to feed the second column of radiating elements via the third filter and to not feed the first column of radiating elements via the third filter, such that the signal strength of the second sub-component of the signal within the second sub-band that is fed to the second column of radiating elements is smaller than the signal strength of the first sub-component of the signal within the second sub-band that is fed to the first column of radiating elements.

8. The feed network of claim 7, wherein the array of radiating elements further comprises a fourth column of radiating elements that is located at a middle portion of the array of radiating elements.

9. The feed network of claim 8, further comprising a fourth filter that is configured to at least partially filter out a signal within the second sub-band, wherein the feed network feeds the fourth column radiating elements via the fourth filter and to not feed the first column of radiating elements via the fourth filter, such that the signal strength of a fourth sub-component of the signal within the second sub-band that is fed to the fourth column of radiating elements is smaller than the signal strength of the first sub-component of the signal within the second sub-band that is fed to the first column of radiating elements.

10. The feed network of claim 9, wherein the third filter and the fourth filter are configured such that the second and fourth sub-components of the signal within the second sub-band that are fed to the second column of radiating elements and the fourth column of radiating elements via the third filter and the fourth filter, respectively, have the same signal strength.

11. The feed network of claim 7, wherein the ratio of the signal strength of the first sub-component of the signal within the second sub-band that is fed to the first column of radiating elements to the signal strength of the second sub-component of the signal within the second sub-band that is fed to the second column of radiating elements is in the range of 1:0.5 to 1:0.9.

12. The feed network of claim 7, wherein the second filter is configured to completely filter out signals within the second sub-band.

13. The feed network of claim 2, wherein the array of radiating elements further comprises a fourth column of radiating elements that is located at a middle portion of the array of radiating elements, and
wherein ratio of the signal strengths of the respective first through fourth sub-components of the signal within the first sub-band that are respectively fed to the first to fourth columns of radiating elements is 0.3:1:0.3:1.

14. (canceled)

15. A feed network for an antenna, the operating frequency band of the antenna comprising a first sub-band and a second sub-band that is at lower frequencies than the first sub-band, wherein
the antenna comprises an array of radiating elements, the array of radiating elements including a first column of radiating elements that is located at a side portion of the array of radiating elements and a second column of radiating elements that is located at a middle portion of the array of radiating elements,
the feed network comprises a first attenuator that attenuates signals within the first sub-band, and
the feed network is configured to feed the first column of radiating elements via the first attenuator and to not feed the second column of radiating elements via the first attenuator, such that the signal strength of a first sub-component of the signal within the first sub-band that is fed to the first column of radiating elements is smaller than the signal strength of a second sub-component of the signal within the first sub-band that is fed to the second column of radiating elements, and the signal strength of a first sub-component of a signal within the second sub-band that is fed to the first column of radiating elements is not smaller than the signal strength of a second sub-component of the signal within the second sub-band that is fed to the second column of radiating elements.

16. The feed network of claim 15, wherein the feed network further comprises a second attenuator that attenuates signals within the first sub-band, and
the feed network is configured to feed a third column of radiating elements that is located at a second side portion of the array of radiating elements via the second attenuator and to not feed the second column of radiating elements via the second attenuator, such that the signal strength of a third sub-component of the signal within the first sub-band that is fed to the third column of radiating elements is smaller than the signal strength of the second sub-component of the signal within the first sub-band that is fed to the second column of radiating elements, and the signal strength of a third sub-component of the signal within the second sub-band that is fed to the third column of radiating elements is not smaller than the signal strength of the second sub-component of the signal within the second sub-band that is fed to the second column of radiating elements.

17. The feed network of claim 16, wherein the first attenuator and the second attenuator are configured such that the first and third sub-components of the signal within the first sub-band that are fed to the first column of radiating elements and the third column of radiating elements via the first attenuator and the second attenuator, respectively, have the same signal strength.

18. The feed network of claim 15, wherein
the feed network further comprises a third attenuator that attenuates signals within the second sub-band,
the feed network is further configured to feed the second column of radiating elements via the third attenuator and to not feed the first column of radiating elements via the third attenuator, such that the signal strength of the second sub-component of the signal within the second sub-band that is fed to the second column of radiating elements is smaller than the signal strength of the first sub-component of the signal within the second sub-band that is fed to the first column of radiating elements.

19. The feed network of claim 18, wherein the array of radiating elements further comprises a fourth column of radiating elements.

20. The feed network of claim 19, further comprising a fourth attenuator that attenuates signals within the second sub-band, and wherein the feed network feeds the second column of radiating elements via the third attenuator and feeds the fourth column of radiating elements via the fourth attenuator.

21-22. (canceled)

23. A feed network for an antenna, the operating frequency band of the antenna comprising a first sub-band and a second sub-band that is at higher frequencies than the first sub-band, wherein
the antenna comprises an array of radiating elements, the array of radiating elements including a first column of radiating elements that is located at a middle portion of the array of radiating elements and a second column of radiating elements that is located at a side portion of the array of radiating elements,
the feed network comprises a first filter that is configured to at least partially filter out a signal within the first sub-band, and
the feed network is configured to feed the first column of radiating elements via the first filter and to not feed the second column of radiating elements via the first filter, such that the signal strength of a first sub-component of the signal within the first sub-band that is fed to the first column of radiating elements is smaller than the signal strength of a second sub-component of the signal within the first sub-band that is fed to the second column of radiating elements, and the signal strength of a first sub-component of a signal within the second sub-band that is fed to the first column of radiating elements is not smaller than the signal strength of a second sub-component of the signal within the second sub-band that is fed to the second column of radiating elements.

24-31. (canceled)
